(19) United States
(12) Patent Application Publication
(10) Pub. No.: US 2025/0189065 A1
(43) Pub. Date: Jun. 12, 2025

(54) PULSATION DAMPENER FOR SANITARY PROCESSES

(71) Applicant: Equilibar, LLC, Fletcher, NC (US)

(72) Inventors: Carlyle Leonard Donevant, IV, Asheville, NC (US); Jeffrey Dean Jennings, Hendersonville, NC (US); Ryan Matthew Heffner, Asheville, NC (US); Zachary Allan Cobb, Candler, NC (US); David A. Reed, Hendersonville, NC (US); Tony Boyd Tang, Mille River, NC (US)

(21) Appl. No.: 18/838,834

(22) PCT Filed: Feb. 24, 2023
(86) PCT No.: PCT/US2023/063231

§ 371 Date: Aug. 15, 2024

Related U.S. Application Data
(60) Provisional application No. 63/314,105, filed on Feb. 25, 2022.

(51) Int. Cl. F16L 55/054

(52) U.S. Cl. CPC F16L 55/054

(57) ABSTRACT

A pulsation dampener includes: a housing extending between a first end and a second end and having an exterior surface and an opposed interior surface; a flexible inner tube disposed inside the housing and having an exterior surface and an opposed interior surface, wherein an outer chamber is defined between the interior surface of the housing and the exterior surface of the inner tube; an inlet orifice disposed in the housing communicating with the outer chamber; a sealing structure disposed in the outer chamber and defining a sealing surface, wherein an outlet orifice extends from the sealing surface through the sealing structure to the exterior surface of the housing; and wherein the inner tube is moveable between an open position in which it is spaced away from the sealing surface, and a closed position in which it seals against the sealing surface so as to close off the outlet orifice.

### CROSS-REFERENCE TO RELATED APPLICATIONS

This application claims the benefit of provisional patent application 63/314,105 filed Feb. 25, 2022, which is incorporated by reference herein.

### BACKGROUND OF THE INVENTION

The present invention relates to pulsation dampening, and more particularly to pulsation dampening for sanitary systems.

The biopharma and food industries commonly use pulsating pumps to drive a process fluid. Many innovations have attempted to reduce the amplitude of pulsations produced by these pumps, such as creating optimized lobe geometry and running multiple piston or diaphragm pumps in parallel out of phase. These techniques help normalize the flow profile, but analyzing in a small timescale shows flow disturbances as these positive displacement pumps stroke.

A growing subset of biopharma process utilize single use equipment wherein conventional stainless components and tubing are replaced by disposable and irradiated polymer tubing and component sets to simplify aseptic validation. Pulsations in the single use industry can be especially damaging to the product media, which can be a living cell or sensitive protein structures. Pulsations could damage the cell wall or other components, which would reduce product yield or quality. Furthermore, pulsations can be highly disruptive to processes such as chromatography, which relies on stable fluid flow through a resin bead column. These fluctuations can disturb the resin beads or the coating they contain. Additionally, filtration processes such as a TFF (tangential flow filtration), which is used in many steps, can suffer from pulsations. Excessive pressures due to pulsations can cause media to be forced through the sensitive filter, which engineers rely on for quality particle classification.

Products are available that offer dampening for the single use industry. However, they typically require large volumes for fluid expansion.

Due to the extreme costs of processed solutions in the biopharma industry, any additional volume hold-up or disruption to the simple flow lines of the fluid are undesirable.

Single use processes typically require full polymer construction, various USP certifications, and designs that can be sterilized by ionizing radiation, chemical, or physical means for biopharma production. These products are consumables, used once and disposed to eliminate expensive clean-in-place equipment and validation testing. A large liquid volume pulsation dampener is inconsistent with typical single-use practices.

Finally, large volume dampers result in a slower time constant, which is not desirable for fast moving systems.

Accordingly, there remains a need for a pulsation dampener suitable for sanitary, aseptic, or sterile applications.

### BRIEF SUMMARY OF THE INVENTION

This need is addressed by a pulsation diameter incorporating a flexible inner tube in a housing.

According to one aspect of the technology described herein, a pulsation dampener includes: a housing extending between a first end and a second end and having an exterior surface and an opposed interior surface; a flexible inner tube disposed inside the housing and having an exterior surface and an opposed interior surface, wherein an outer chamber is defined between the interior surface of the housing and the exterior surface of the inner tube; an inlet orifice disposed in the housing communicating with the outer chamber; a sealing structure disposed in the outer chamber and defining a sealing surface, wherein an outlet orifice extends from the sealing surface through the sealing structure to the exterior surface of the housing; and wherein the inner tube is moveable between an open position in which it is spaced away from the sealing surface, and a closed position in which it seals against the sealing surface so as to close off the outlet orifice.

According to another aspect of the technology described herein, a pulsation dampener includes: a housing extending between a first end and a second end and having an exterior surface and an opposed interior surface; a flexible inner tube disposed inside the housing and having an exterior surface and an opposed interior surface, wherein an outer chamber is defined between the interior surface of the housing and the exterior surface of the inner tube; an outlet orifice communicating with the outer chamber and the exterior surface of the housing; and a pressure regulator coupled in fluid communication with the outlet orifice and configured to regulate a gas pressure within the outer chamber.

According to another aspect of the technology described herein, a pulsation dampener includes: a housing extending between a first end and a second end and having an exterior surface and an opposed interior surface; a flexible inner tube disposed inside the housing and having an exterior surface and an opposed interior surface, wherein an outer chamber is defined between the interior surface of the housing and the exterior surface of the inner tube; and a resilient cushion element disposed in the outer chamber.

### BRIEF DESCRIPTION OF THE DRAWINGS

The invention may be best understood by reference to the following description taken in conjunction with the accompanying drawing figures in which:

FIG. 1 is a schematic sectional view of a pulsation dampener;

FIG. 2 is a schematic sectional view of an alternative pulsation dampener;

FIG. 3 is a schematic sectional view of an alternative pulsation dampener;

FIG. 4 is a schematic sectional view of an alternative pulsation dampener incorporating a valve;

FIG. 5 is a schematic sectional view of an alternative pulsation dampener incorporating a sleeve;

FIG. 6 is a schematic sectional view of an alternative pulsation dampener incorporating a sleeve;

FIG. 7 is a schematic sectional view of an alternative pulsation dampener incorporating an electronic pressure regulator;

FIG. 8 is a schematic sectional view of an alternative pulsation dampener incorporating a cushioning element;

FIG. 9 is a schematic sectional view of an alternative pulsation dampener incorporating a cushioning element;

FIG. 10 is a schematic sectional view of a housing for a pulsation dampener;

FIG. 11 is a schematic side view of a housing for a pulsation dampener;

FIG. 12 is a schematic end view of the housing of FIG. 11; and

FIG. 13 is a schematic diagram of a process flow incorporating a pulsation dampener.

### DETAILED DESCRIPTION OF THE INVENTION

Described herein are several example embodiments of a pulsation dampening apparatus which includes a flexible inner tube positioned inside a rigid housing. This may be referred to as a “tube in tube” type device. The inner tube has an inner surface which is wetted with a process fluid, and an outer, non-wetted surface that faces an inner surface of the housing. An outer chamber is defined between the inner tube and the housing.

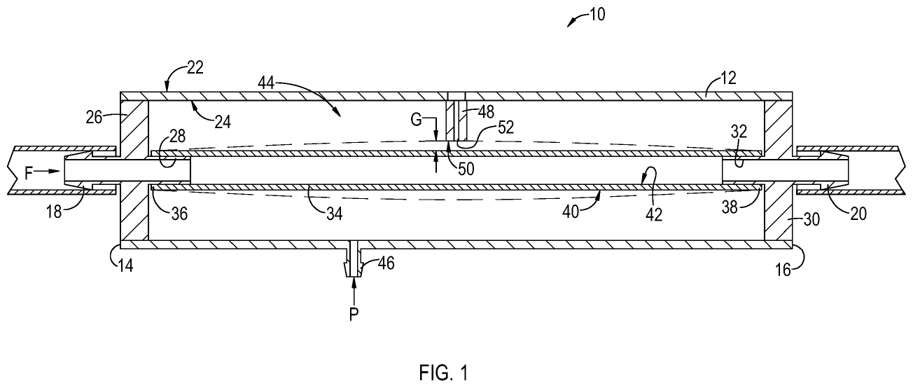

Now, referring to the drawings wherein identical reference numerals denote the same elements throughout the various views, FIG. 1 illustrates an exemplary embodiment of a pulsation dampener 10. The pulsation dampener 10 includes a housing 12 extending from a first end 14 to a second end 16. Some means are provided for coupling the pulsation dampener 10 to a flowpath containing process fluid. In the illustrated example, a first connector 18 is disposed at the first end 14 and a second connector 20 is disposed at the second end 16.

The housing 12 has a closed circumferential perimeter with an exterior surface 22 and opposed interior surface 24. In the illustrated example, the first end 14 is closed off by a first end cap 26 that defines the first connector 18, as well as a first stub tube 28, and the second end 16 is closed off by a second end cap 30 that defines the second connector 20, as well as a second stub tube 32.

The housing 12 is made from a relatively rigid material, “rigid” being defined in this context as a material stiff enough not to have significant deflection at system pressures. The housing material is selected to provide adequate structural support to the inner tube described below for the pressure environment needed (typically 60 psi or less, but some embodiments could get as high as 150 psi). Nonlimiting examples of suitable rigid materials include stainless steel alloys or hard polymers, such as polymers with hardness in the Shore D range. Depending on system pressures, materials such as thick-walled rubber tubing could be used for housing 12.

An inner tube 34 extending from a first end 36 to a second end 38 is disposed inside the housing 12. The inner tube 34 has a closed circumferential perimeter with an exterior surface 40 and an opposed interior surface 42.

The inner tube 34 is made from a flexible material, “flexible” being defined in this context as a material soft enough to deflect at system pressures. Various materials can be considered for the inner tube 34, depending on the pressure rating, and on the mode of operation of the inner tube. The inner tube 34 may be elastic or non-elastic. In the case of an elastic material, the inner tube 34 is able to stretch a significant amount at system pressures. In the case of a non-elastic material, the inner tube 34 would not be expected to stretch a significant amount at system pressures. It will of course be understood that the property of elasticity exists over a range. For example, polyethylene has perhaps 130-200% elongation to failure and would be considered a non-elastic material for purposes of the present invention. In contrast, soft elastomers may have over 200% elongation to failure, say in the range of 200% to 500% elongation to failure, and would be considered elastic material for the purposes of the present invention. Examples of suitable elastic materials include any flexible elastomeric material, such as silicones, urethanes, or rubber/elastomers such as: fluorocarbon-based fluoroelastomer materials (FKM), ethylene propylene diene monomer rubber (EPDM), thermoplastic polyurethanes (TPU), or thermoplastic elastomers (TPE). One particular example of a suitable elastic material is thin tubing with a hardness in the Shore A range of 30 to 50. A highly elastic inner tube 34 can expand its volume to accommodate the volume of the wave pulse with a pressure increase that is within a desired pressure pulsation window. Examples of suitable inelastic materials include polymers such as polyethylene (PE), for example thin PE tubing with a hardness in the Shore D range.

The physical and material characteristics of inner tube 34 affect the functionality of the invention. Two important characteristics of this inner tube 34 are its thickness (or thickness/diameter ratio) and its modulus of elasticity. The inner tube 34 will have some tube outer diameter (d) equivalent to or less than the inner diameter of the housing 24. In the example of an elastic inner tube, a ratio exists between the inner tube outer diameter (d) and the wall thickness (t) of the inner tube 34. In preferred examples this ratio is t/d=1/10 or less. In the example of an inelastic inner tube, the t/d ratio is less important, and in preferred examples thickness (t) may lie in a range of 0.003 inches to 0.006 inches. The second important characteristic of the inner tube 34 is the modulus of elasticity of the wetted inner tube 34. Elongation % can be used as a method to identify material classes (elastic vs non-elastic) for the inner tubing 34, as describe above. Furthermore, the material specific modulus of elasticity should be selected to allow the tubing to expand appropriately in presence of internal pressure spikes. Excessive modulus of elasticity could lead to a situation where the system internal pressures do not provide enough available stress in the tubing wall to expand and contact the sealing surface. Alternatively, with too low of a modulus, the material may stretch excessively under internal tubing stress and be unable to re-compress at the proper time scale during a low pressure phase.

For example, if an upstream pump has a pulse wave volume of 10 ml and the user desires a pressure deviation of less than +/−0.5 psi, then the expansion properties of the inner tube 34 must allow for both the expansion of the tubing, and the compression of the support air to remain within this window.

The housing 12 and the inner tube 34 are arranged such that a closed volume referred to as an “outer chamber” 44 is defined between the interior surface 24 of the housing 12 and the exterior surface 40 of the inner tube 34. In the illustrated example, this is accomplished by having the first end 36 of the inner tube 34 connected to the first stub tube 28 and the second end 38 of the inner tube 34 connected to the second stub tube 32.

The housing 12 incorporates at least one inlet orifice 46 of a known or controlled diameter. The inlet orifice 46 could be a fixed structure such as a drill hole or an adjustable device such as a needle valve. This is connected in flow communication with a gas pressure source shown schematically at “P”. The gas pressure source P could be, for example, one or more pressurized gas cylinders, a dedicated pump, or a remotely-located air compressor coupled to air distribution piping (i.e. “shop air”).

The housing 12 incorporates at least one sealing structure 48 extending inward from its interior surface 24 towards the inner tube 34. In the illustrated example, the sealing structure 48 is a small cylinder. It incorporates a radially-inward-facing sealing surface 50 which is positioned to define a radial gap “G” from the inner tube 34 at static conditions. This gap G would be selected in part based on the type of material used for the inner tube 34. An elastic material can stretch a significant amount and therefore can tolerate a relatively large gap G. For example, one could expect an increase in the perimeter of the inner tube 34 between 5% and 100% from the relaxed state to the point of sealing closure. Preferably the increase in perimeter is in the range of 10% to 50%. An inelastic material would not stretch a significant amount and would therefore be used with a smaller gap G. For example, one could expect an increase in the perimeter of the inner tube 34 of less than 4% from the relaxed state to the point of sealing closure. Preferably the increase in perimeter is less than 2%. With the inelastic material, essentially all of the volumetric changes would be derived from changes in the curvature of the inner tube, not stretching of the perimeter.

At least one outlet orifice 52 extends through the sealing structure 48 from the sealing surface 50 to the exterior surface 22 of the housing 12. In operation, the outlet orifice 52 communicates with ambient pressure.

In some applications, the sealing structure 48 may be manufactured from a rigid material. For applications where the inner tube 34 is a more delicate material, a rigid structure may accelerate abrasion or wear in the inner tube 34. The longevity of the inner tube 34 may be improved by changing the material of the sealing structure 48 to have compressibility. One example is Shore 10A silicone.

The operation of the pulsation dampener may be understood with reference to FIG. 1. A process fluid “F” flows the inner tube 34. It will be understood this flow F is driven by a positive-displacement pump and therefore exhibits a pulsating characteristic. A gas pressure source P is coupled to the inlet orifice 46.

When the inner tube 34 is not expanded due to excess process pressure, gas flows from the inlet orifice 46, through the outer chamber 44 and out the outlet orifice 52 to atmosphere.

When a pressure pulse enters the inner tube 34, it expands until it touches the outlet orifice 52, as shown by the dashed lines in FIG. 1. At that time, the outlet flow is blocked. Because the inlet flow is constant, the air pressure in the outer chamber 44 slowly increases. As the pressure pulse passes out of the inner tube 34, it will collapse and disengage the outlet orifice 52. As this happens, at some point the exhaust flow is re-established and the pressure automatically remains within a pressure window that is related to the fluid pressure (but also less the differential pressure due to the stretching of the inner tube 34).

An objective of this design is to ensure that the differential pressure between the liquid and gas sides of the inner tube 34 is as small as possible. The differential pressure will be governed by the selection of diameter, thickness and elasticity of the inner tube, along with the expansion diameter required to reach the outlet orifice. In the case of higher process fluid pressures and elastic inner tube materials, the differential pressure may be significant, for example a few psi. In the case of lower process fluid pressures and/or an inelastic inner tube, the differential pressure may be nearly zero. The preferred embodiment will be to ensure that the inlet orifice 46 is appropriately sized. In essence, this proposal presents an energy exchange between the liquid and pneumatic environments, working in tandem to borrow energy from the liquid during high pressure high flow events and storing temporarily in pneumatic compression. In the opposite case once this pulse evolves (milliseconds later), the energy is then exchanged back to the liquid through pneumatic expansion, acting like a pump to re-accelerate the fluid to normalize the pressure and flow in the system.

It is noteworthy that the air will typically release from the valve in a pulsing action in sync with the pulsing of the fluid. The selection of the outlet orifice sizing is important because if the air is exhausted too fast, the timing of this loss of air pressure will reinforce the loss of fluid pressure and increase the pulsations. However, if the outlet orifice is sized appropriately, and if the outer pressure volume is large enough (the time constant established between these two variables), then the positive reinforcement effect is insignificant and the larger dampening effect of having a low modulus tubing backed up by the air padding is much greater than the positive reinforcement of the valve action timing.

In practice, the sizes of the inlet orifice 46 and the outlet orifice 52 are selected taking into consideration the process fluid pressure and the gas pressure source pressure.

An example of a specific application is as follows. Typical single use systems may present pulsations at a 4 psi amplitude, and common system pressures of 10-20 psig. Industry wide pressures would typically range from 0-60 psig, thus requiring that the gas pressure supply P be >60 psi. The single use industry uses a variety of polymer tubings, such as silicone, TPU, C-Flex, PE/PU, and polypropylene. Since the goal is to establish volume changes, selection of the wall thickness and material elasticity will be important to generate the volume displacement profile needed for the application. With elastic tubing, without air backing, the applied pressure will elastically stretch the typical thin wall tubing to a near-plastic region. However, air backing will reduce the dP and reduce the stretching to maintain the material in the elastic deformation region of its material curve, offering the most volume displacement at low pulsation pressure. The preferred configuration would be to select a thin wall material with a Shore range similar to 10A-40A materials. These tubings would generate approximately 0.125 in. radial displacement under small pressure gradient loads, such as the 4 psi amplitude case above. This would result in an volume displacement of approximately 0.25 in³ per linear inch of tubing, for a 0.5 inch diameter tube. The gap between the inner tube and the housing defines the maximum volume expansion capability of this system. Although this expansion in tubing will create compression and increase air pressure, the general function of this expansion will be to seal the mechanism, resulting in a rapid increase in air pressure. Once air pressure and liquid pressure are at equilibrium, the tubing radial displacement will also be stable, resulting in significantly reduced pulsations. Testing has shown that use of the pulsation dampener as described herein can reduce pulsations by a factor of 5× to 10×, and may be able to reduce pulsations by a factor of 20×.

In one example, the outlet orifice 52 may have a diameter of 0.020 in. and the inlet orifice 46 may have a diameter of 0.008 in., where the gas pressure source is 30 psig and the fluid pressure is in a 15 psig range.

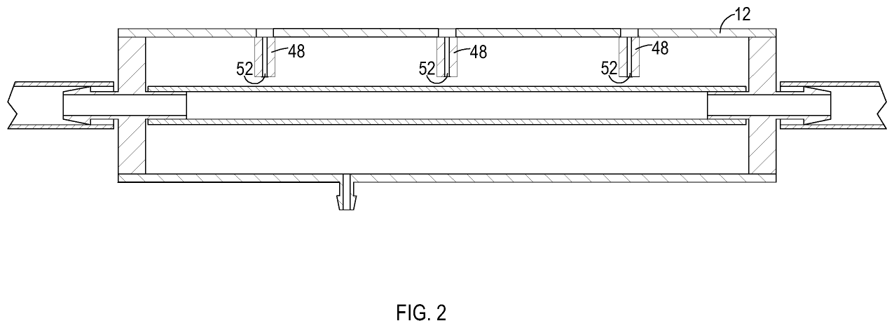

Various modifications of this basic apparatus may be implemented and are described below with reference to FIGS. 2-6.

In one configuration, shown in FIG. 2, multiple sealing structures 48 are arranged along a long axis of the housing 12, each sealing structure 48 having an outlet orifice 52 communicating with the exterior surface of the housing 12.

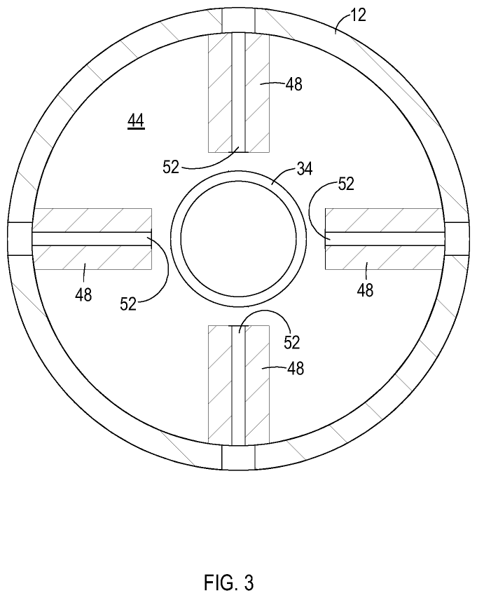

In one configuration, shown in FIG. 3, multiple sealing structures 48 each including one or more outlet orifices 52 are arranged in a radial array about the circumference of the housing 12.

The features shown in FIGS. 2 and 3 may be combined; for example, multiple axillary spaced-apart sealing structures 48 may be provided, each including two or more outlet orifices 52 arranged in a radial array about their circumference.

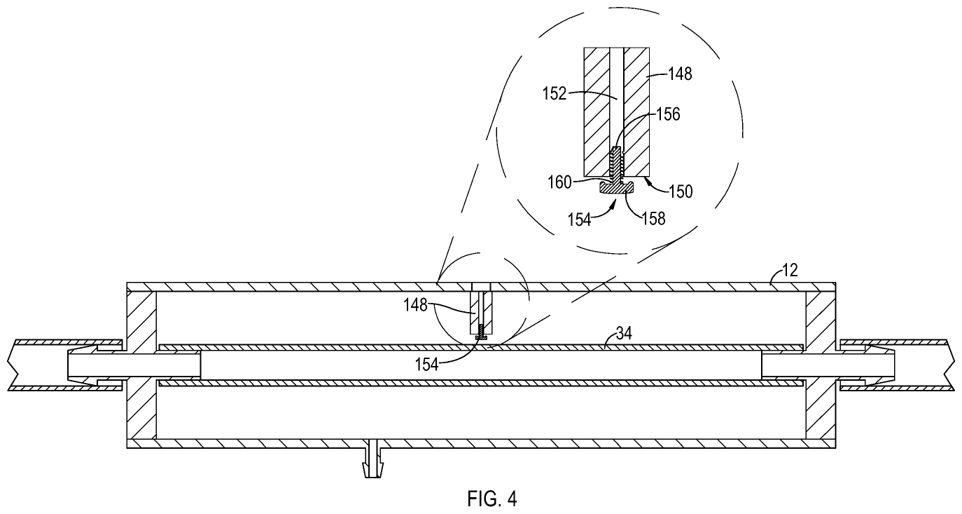

Under some circumstances, very soft tubing used for the inner tube 34 can stretch and try to maintain contact with the suction of the outlet orifice 52, creating a “popping” or “sucking” effect when the stretched tubing releases. This creates undesirable oscillations. This effect can be addressed by incorporating a valve element at the outlet orifice. FIG. 4 illustrates a sealing structure 148 having a sealing surface 150 and an outlet orifice 152. A valve element 154 with a stem 156 and a head 158 is received in the outlet orifice 152 and is movable between a open position (shown) in which fluid can pass through the outlet orifice 152, and a closed position (not shown) in which the head 158 seals against the sealing surface 150, blocking flow into the outlet orifice 152. Optionally, a spring 160 biases the valve element 154 towards the open position. In operation, the inner tube 34 would interact with the valve element 154 rather than sealing directly against the outlet orifice 152.

Alternatively, a discrete valve (not shown) such as normally open stem valve having a similar action (i.e. whereas flow is blocked when a sensing element is depressed by the inner tube) could be coupled to the sealing structure 148. Small valves suitable for this purpose are commercially available from Clippard Instrument Laboratory, Inc., Cincinnati, Ohio 45239 USA.

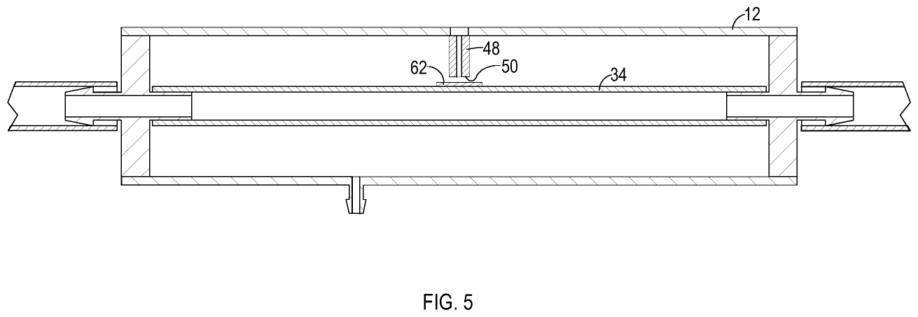

Another optional method to avoid suction and attraction between the soft elastomeric inner tube 34 and the sealing structure 48 is to interpose a harder material between the inner tube 34 and the sealing structure 1. FIG. 5 shows an example in which a patch 62 of relatively harder material, such as a Shore D polymer, is adhered directly to a portion of the inner tube 34.

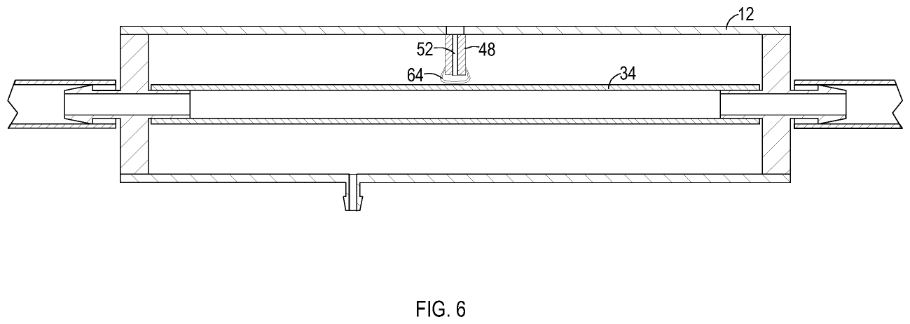

FIG. 6 shows an example in which an open-ended shroud 64 of relatively harder material, affixed to the sealing structure 48, with the flexural mechanics of the shroud 64 helping to assure that the material extends while not in contact with the inner tube 34.

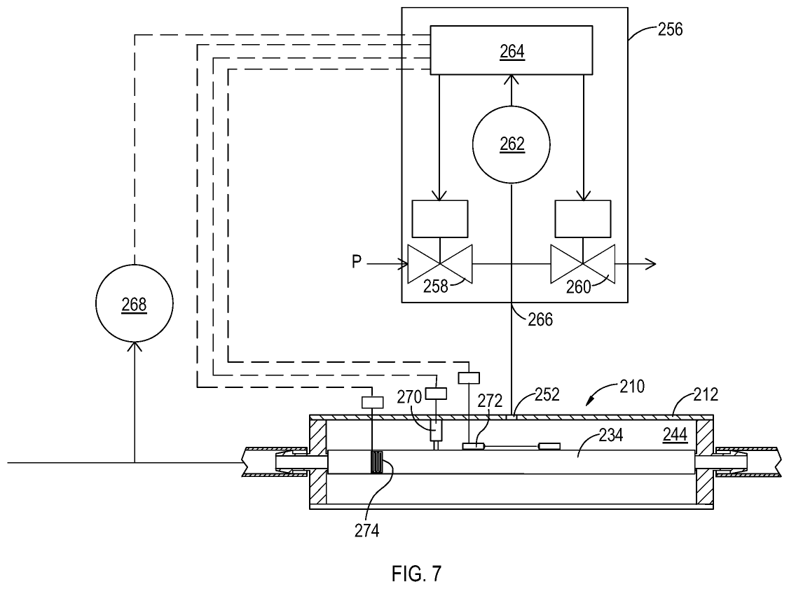

As an alternative to controlling air pressure in the outer chamber by direct interaction of the inner tube with an outlet orifice, a device such as an electronic regulator may be used to control the ideal air pressure in the outer chamber directly. For example, FIG. 7 illustrates a pulsation dampener 210 with an inner tube 234, housing 212, outer chamber 244, and a outlet orifice 252.

An electronically-controlled, electro-pneumatic pressure regulator 256 of a known type is illustrated as one example of a regulator that may be used for this purpose.

The pressure regulator 256 includes a fill valve 258, a drain valve 260, and a pressure transducer 262, all of which are operatively coupled to an electronic controller 264. Each of the valves 258, 260 is movable between an open state or position permitting fluid flow therethrough and a closed state or position blocking flow therethrough, under control of the electronic controller 264. For example, the valves 258, 260 may be solenoid-operated valves. Optionally, one or both of the valves 258, 260 may be of a proportional type which can be placed in an intermediate position between the open and closed positions. The pressure transducer 262 is operable to sense fluid pressure and generate a signal representative of the magnitude of the pressure. The pressure regulator 256 includes an inlet port 266 which is connected to the outlet orifice 252 of the pulsation dampener 210. The fill valve 258 is connected in fluid communication to the gas pressure supply P as described above. The drain valve 260 is vented to atmosphere. The pressure regulator 256 includes a common internal fluid connection amongst the inlet port 266, the fill valve 258, the pressure transducer 262, and the drain valve 260.

Opening of the fill valve 258 permits gas to enter the outer chamber 244 of the pulsation dampener 210. Opening of the drain valve 260 permits fluid to drain from the outer chamber 244.

The pressure regulator 256 controls fluid pressure in the outer chamber 244 to converge to a setpoint value. The feedback loop is implemented by the electronic controller 264, referencing the pressure signal from the pressure transducer 262.

The electronic controller 264 increases the system pressure by allowing gas flow into the outer chamber 244 by opening the fill valve 258 for a short duration. The electronic controller 264 decreases the outer chamber pressure by allowing fluid to drain from the outer chamber 244 by opening the drain valve 260 for a short duration. Binary valve action is highly suitable for this approach, though analog valve action may be obtained by use of pulse width modulation or varying current to the solenoid coil.

The desired air pressure to be maintained by the pressure regulator 256 is equal or less than the nominal or average process fluid pressure. Tubing stretch will be affected by lowering this target pressure less than the fluid pressure. Accordingly, in practice a variable setpoint having a known relation to the process fluid pressure will be provided to the pressure regulator 256. The process fluid pressure may be sensed by various means.

In one example seen in FIG. 7, the process fluid pressure is measured by a wetted sensor such as a pressure transducer 268. This may be the case where the end user has a wetted sensor already installed in the process flow loop. The exemplary sensor 268 is shown connected to the process piping upstream of the pulsation dampener 210.

In another example, a mechanical transducer 270 operable to measure displacement and produce a signal representative thereof may be installed inside the outer chamber 244 such that the flexible inner tube 234 presses on the transducer 270, relaying a signal which may be used to approximate fluid pressure. This is a type of nonwetted sensor which does not require fluid sealing.

In another example, an optical sensor such as a light curtain sensor 272 may be used to measure the expansion of the inner tube 234. The light curtain sensor 272 would be placed closely adjacent to the inner tube 234. The tripping point of the light curtain sensor 272 corresponds to a predetermined differential pressure between the process fluid and the outer air.

In another example, expansion of the inner tube 234 may be measured by a strain gauge or similar measurement device. FIG. 7 shows a strain gauge 274 contacting the inner tube 234 so as to be able to measure expansion of the inner tube 234.

It will be understood that alternative configurations of pressure regulators may be substituted for the regulator 256 described above. For example, the pulsation dampener may be provided with an inlet orifice coupled to a gas pressure source P described above, and a single valve electro-pneumatic pressure regulator may be used to control outflow from the outlet orifice 252.

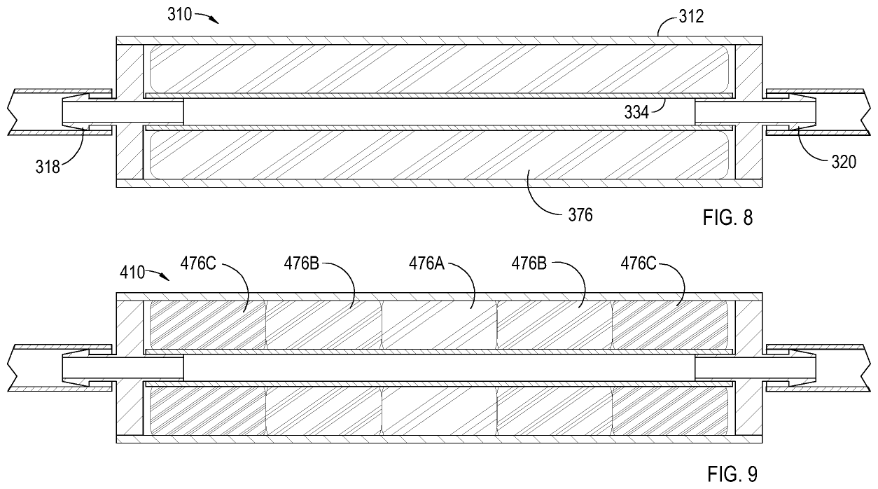

As an alternative to the concepts described above, passive dampening could be implemented by placing a resilient cushioning material in the outer chamber of the pulsation dampener. For example, FIG. 8 illustrates a pulsation dampener 310 with an inner tube 334, housing 312, first connector 318 and second connector 320. Unlike the embodiments described above, the housing 312 is sealed and contains no inlet or outlet orifices. A resilient compressible cushion element 376 is disposed in the outer chamber 344.

The cushion element 376 could be a material such as open cell foam, closed cell foam, silicone, rubber, or other thermoplastic Moderate hardness silicones like a Shore 20A-60A, or weaker Shore D rubbers would be good options, along with moderate to stiffer closed cell foams. Any material selected would need to be compressible.

The non-wetted compressible cushion element 376 would have less range of effectiveness compared to the embodiments described above; in practice, the compressibility of the cushion element 376 would need to be appropriately selected for a given pressure and pulsation environment.

FIG. 9 shows an alternative example pulsation dampener 410 in which multiple side-by-side cushion elements are used, arranged in groups labeled 476A, 476B, 476C. The compressibility of the cushion elements in the different groups are different from each other, i.e. 476A≠476B≠476C. The compressibility may increase or decrease sequentially. Flow dampening and normalizing would benefit more from the sequential material, as shown in FIG. 9, since this differential hardness would help accelerate the fluid during periods of low flow.

These non-wetted cushion elements shown in FIGS. 8 and 9 are springs at their nature, so other materials such as springs could be utilized in single or multi-stage configurations. These could be, for example, linear compression springs or radial/conical springs.

In some embodiments, the pulsation dampener may be a single unitary device with the housing and the inner tube permanently assembled. Alternatively, the housing may be formed as a separate unit and provided with some means of being assembled to the inner tube in a sealed configuration. This may be useful, for example in applications where the apparatus is to be gamma irradiated for sterilization and it is desirable to have the housing be a separate reusable item which does not have to be separately sterilized.

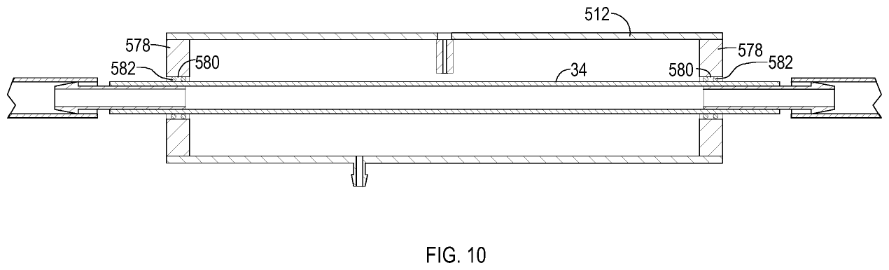

In the example shown in FIG. 10, the housing 512 is a tubular shape with a closed circumferential perimeter and end caps 578. Each end cap 578 includes a tubing passage 580 with an appropriate seal 582 such as the illustrated O-rings. The inner tube 34 may be assembled by passing through the seals 582.

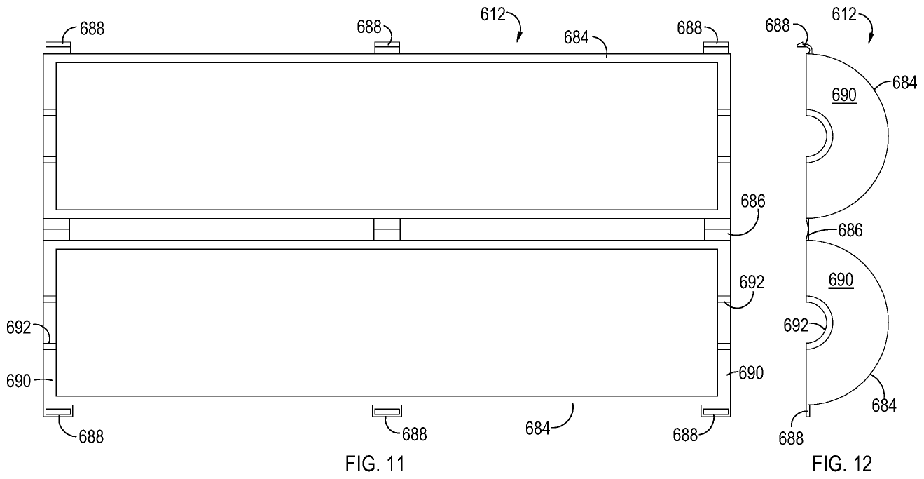

The example shown in FIGS. 11 and 12, the housing 612 is a clamshell configuration with two semi-cylindrical halves 684 joined by live hinges 686 and provided with locking tabs 688. Each half 684 includes a pair of semicircular end plates 690 with tubing cutouts 692. When folded together the halves 684 define the cylindrical housing.

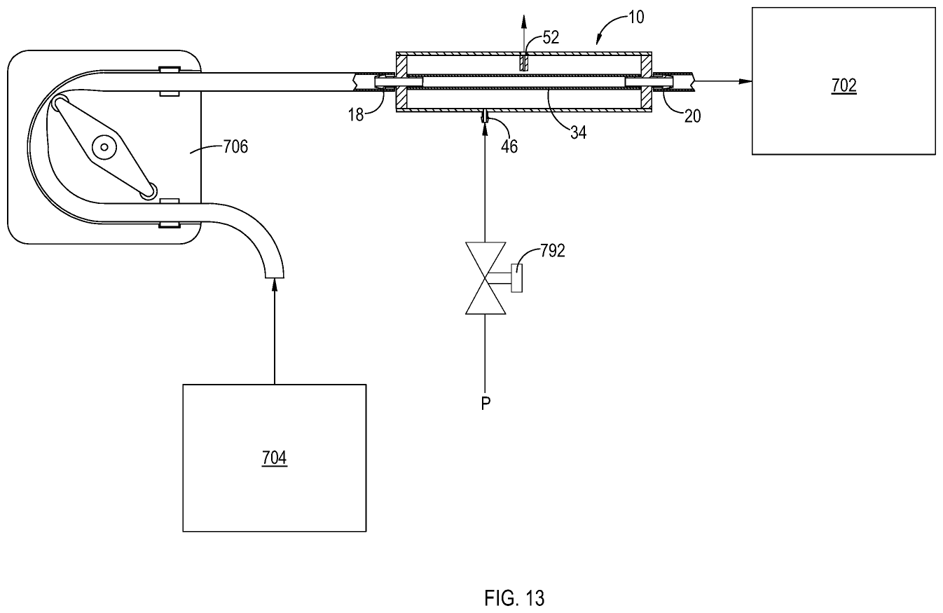

FIG. 13 is a schematic representation of a representative industrial process 700 incorporating a pulsation dampener 10 described above. This is but one of many types of process system which utilize a pulsation dampener. The system includes a process vessel 702 to be supplied with process fluid from a supply 704. The liquid supply 704 is pumped to the process vessel 702 using a positive-displacement pump 706 such as a peristaltic pump. The first port 18 of the pulsation dampener 10 is connected to the output of the pump 706. The second port 20 of the pulsation dampener 10 is connected to the process vessel 702. The inlet orifice 46 of the pulsation dampener 10 is connected to the gas supply P, optionally through variable restriction needle valve 792. The outlet orifice 52 of the pulsation dampener 10 may be vented to atmosphere.

The apparatus described above has numerous advantages over prior art pulsation dampening systems. It is ready sterilizable, suitable for use in a single-use environment, and does not require excessive expansion volume to operate.

The foregoing has described apparatus for pulsation dampening. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

1. (canceled)

2. (canceled)

3. (canceled)

4. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube;
an inlet orifice disposed in the housing communicating with the outer chamber;
a plurality of individual sealing structures disposed in the outer chamber in a radial array about a periphery of the housing, each sealing structure defining a sealing surface, wherein an outlet orifice extends from the sealing surface through the sealing structure to the exterior surface of the housing; and
wherein the inner tube is moveable between an open position in which it is spaced away from the sealing surface, and a closed position in which it seals against the sealing surface so as to close off the outlet orifice.

5. (canceled)

6. (canceled)

7. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube;
an inlet orifice disposed in the housing communicating with the outer chamber;
a sealing structure disposed in the outer chamber and defining a sealing surface, wherein an outlet orifice extends from the sealing surface through the sealing structure to the exterior surface of the housing, wherein an open-ended shroud of a material which is relatively harder then a material of the tube is affixed to the sealing structure; and
wherein the inner tube is moveable between an open position in which it is spaced away from the sealing surface, and a closed position in which it seals against the sealing surface so as to close off the outlet orifice.

8. (canceled)

9. A pulsation dampener, comprising:
a housing extending between a first end and a second end and having an exterior surface and an opposed interior surface, wherein the housing has a clamshell configuration including two halves joined by one or more hinges;
a flexible inner tube disposed inside the housing and having an exterior surface and an opposed interior surface, wherein an outer chamber is defined between the interior surface of the housing and the exterior surface of the inner tube;
an inlet orifice disposed in the housing communicating with the outer chamber;
a sealing structure disposed in the outer chamber and defining a sealing surface, wherein an outlet orifice extends from the sealing surface through the sealing structure to the exterior surface of the housing; and
wherein the inner tube is moveable between an open position in which it is spaced away from the sealing surface, and a closed position in which it seals against the sealing surface so as to close off the outlet orifice.

10. (canceled)

11. (canceled)

12. (canceled)

13. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube;
an outlet orifice communicating with the outer chamber and the exterior surface of the housing;
a pressure regulator coupled in fluid communication with the outlet orifice and configured to regulate a gas pressure within the outer chamber; and
an optical sensor disposed in the outer chamber and operatively connected to the pressure regulator.

14. (canceled)

15. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube;
an outlet orifice communicating with the outer chamber and the exterior surface of the housing; and
a pressure regulator coupled in fluid communication with the outlet orifice and configured to regulate a gas pressure within the outer chamber; and
a strain gage coupled to the inner tube and operatively connected to the pressure regulator.

16. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube;
an outlet orifice communicating with the outer chamber and the exterior surface of the housing; and
a pressure regulator coupled in fluid communication with the outlet orifice and configured to regulate a gas pressure within the outer chamber; and
a pressure transducer coupled in flow communication with an interior of the inner tube and operatively coupled to the pressure regulator.

17. (canceled)

18. (canceled)

19. A pulsation dampener, comprising:
a housing extending between a first end and a second end and having an exterior surface and an opposed interior surface;
a flexible inner tube disposed inside the housing and having an exterior surface and an opposed interior surface, wherein an outer chamber is defined between the interior surface of the housing and the exterior surface of the inner tube; and
a resilient cushion element disposed in the outer chamber, wherein the cushion element comprises a series of individual segments having differing stiffnesses.
